(19) United States
(12) Patent Application Publication
(10) Pub. No.: US 2026/0319784 A1
(43) Pub. Date: Oct. 15, 2026

(54) OVER-THE-AIR AUTOMOTIVE UPDATES

(71) Applicant: Re:Car Inc., Troy, MI (US)

(72) Inventors: Joe McCallum, Lake Orion, MI (US); Neil Borkowicz, Troy, MI (US); Mufadal Amiji, Auburn Hills, MI (US); Fady Ibrahim, Sterling Heights, MI (US)

(21) Appl. No.: 19/645,850

(22) Filed: Apr. 13, 2026

Related U.S. Application Data
(60) Provisional application No. 63/793,141, filed on Apr. 23, 2025.
(60) Provisional application No. 63/788,530, filed on Apr. 14, 2025.

(51) Int. Cl. G06F 8/65

(52) U.S. Cl. CPC G06F 8/65

(57) ABSTRACT

A method of updating firmware and/or software in a vehicle comprising transmitting a payload of a firmware and/or software update to a mobile device over-the-air, authenticating the mobile device relative to the vehicle, transmitting the payload to the vehicle via a wired connection, and performing one or more validations of the payload at the mobile device and/or the vehicle.

### CROSS REFERENCE TO RELATED APPLICATIONS

The present application claims benefit to U.S. Provisional Application Nos. 63/788,530, filed Apr. 14, 2025, and 63/793,141, filed Apr. 23, 2025, which are incorporated herein by reference in their entirety.

### FIELD

These teachings relate to a method and system for over-the-air updates to vehicle firmware and software.

### BACKGROUND

Various vehicle devices operate in accordance with firmware and software, which may be updated from time to time to fix bugs, patch security holes, improve performance, modify user experience, add new features, improve safety features, or improve the compatibility of different devices.

Typically, software updates are delivered by dealership service centers, when a vehicle is brought in for servicing. Generally, updates are delivered relatively infrequently, such as in the event of vehicle performance issues or vehicle recall. Often, these updates are merely directed to human-machine interfaces (HMIs) such as infotainment and navigation systems.

Compared to internal combustion engine (ICE) vehicles, electric vehicles (EVs) rely more on software to function. So, with the proliferation of EVs in the market, there are needs for more frequent firmware and software updates, and the vehicle systems involved include systems critical for vehicle function. However, it is desirable to avoid the need for bringing the vehicle into a service center for software and firmware updates.

Firmware updates are much more complex than software updates. Firmware is a type of software that functions for low-level control of hardware, and any mistakes in the process could result in the hardware becoming non-functional. In this regard, firmware over-the-air (FOTA) to the vehicle has been limited in practice.

There are some vehicles that receive OTA updates to an on-board telematics module with wireless network communication capabilities. However, these telematics modules add cost to the vehicle.

There is a need for a method and system for updating firmware and software by a vehicle owner, without the need for specialized tools or knowledge.

There is a need for a method and system for updating firmware on a vehicle without a telematics module.

### SUMMARY

The present teachings describe a method of updating firmware and/or software in a vehicle, which may address at least some of the needs identified above. The method may comprise: transmitting a payload of a firmware and/or software update to a mobile device over-the-air, the payload corresponding with a target accessory or ECU of the vehicle, authenticating the mobile device relative to the vehicle, transmitting the payload to the vehicle via a wired connection, and performing one or more validations of the payload at the mobile device and/or the vehicle.

The authentication may confirm the owner of the mobile device is the owner of the vehicle.

The mobile device may signally communicate with a gateway module of the vehicle, which receives the payload and pushes the payload to the accessory or ECU.

The vehicle may be free of an on-board telematics module.

The vehicle may be an electric vehicle. The vehicle may be a reconfigurable vehicle.

The one or more validations may include, at the mobile device, a cycle redundancy check, validating signatures and/or certificates, validating compatibility of the payload with the associated accessory or ECU, validating memory storage medium capacity available to receive the payload, or any combination thereof. Preferably at least a cycle redundancy check. An error may result in the mobile device rejecting the payload, and optionally re-transmitting the payload to the mobile device.

The method may further comprise performing a functional request to all accessories and/or ECUs on-board the vehicle for an identifier (e.g., a part number); and comparing the identifiers with all firmware and/or software updates available on a cloud-based storage platform.

The one or more validations may include, at the gateway module, a cycle redundancy check, validating signatures and/or certificates, validating compatibility of the payload with the associated accessory and/or ECU, validating memory storage medium capacity available to receive the payload, or any combination thereof . An error may result in the gateway module rejecting the payload, and optionally re-transmitting the payload to the gateway module.

The method may further comprise disconnecting the mobile device from the vehicle after successful validation at the gateway module.

The method may further comprise a pre-condition sequence including: (A) ensuring the vehicle is in park and/or has a vehicle speed of 0 km/h; (B) ensuring a sufficient vehicle battery condition and/or ensuring the vehicle is connected to a charger; (C) setting an update flag; (D) disabling propulsion of the vehicle; or any combination thereof. Propulsion of the vehicle may remain disabled during the firmware and/or software update. In the event of an error in the pre-condition sequence, retry attempts may be performed up to a maximum quantity of retry attempts, and if a maximum quantity of retries is exceeded, failure may be reported to the mobile device.

The method may further comprise gathering accessory or ECU statistics, accessory or ECU information from Diagnostic Standardized Identifications, and Diagnostic Trouble Codes.

The method may further comprise sending a functional request to the accessory or ECU for Tester Present. The functional request may be sent on a periodic basis.

The method may further comprise: (A) sending a functional request to the accessory or ECU for Diagnostic Session Control to change to a diagnostic session; (B) checking programming pre-conditions in a Routine Control Service; (C) sending a functional request to the accessory or ECU for disabling Diagnostic Trouble Codes; (D) sending a functional request to the accessory or ECU enabling receive by the accessory or ECU and disabling transmission by the accessory or ECU; and (E) executing a program counter. An error in (B) or (E) may result in a retry loop up to a maximum quantity of retries. A notification may be sent to the mobile device if the maximum quantity of retries is exceeded.

The method may further comprise a main programming session including: starting a programming session, sending a seed request from the gateway module to the accessory or ECU and sending the seed back from the accessory or ECU to the gateway module, generating a key by the gateway module and validating the key by the accessory or ECU, and entering a Write Data by Identifier Service. In the event of a No Response Code or no response from the accessory or ECU in any of the foregoing sub-steps, retry attempts may be performed up to a maximum quantity of retry attempts. A hard reset of the accessory or ECU may be performed if the maximum quantity of retries is exceeded.

The method may further comprise an erase, download, and check services session including: (A) erasing memory; (B) sending a download request to the accessory or ECU; (C) transmitting payload data and/or data segments; (D) checking memory in a Routine Control Service; and (E) detecting additional data blocks for one or more firmware and/or software updates for one or more additional accessories and/or ECUs, and executing steps (A) through (E) in the erase, download, and check services session for each additional data block. In the event of a No Response Code or no response from the accessory or ECU in any of the foregoing sub-steps, retry attempts may be performed up to a maximum quantity of retry attempts. A hard reset of the accessory or ECU may be performed if the maximum quantity of retries is exceeded.

The method may further comprise checking programming dependencies in a Routine Control Service, and performing a hard reset. In the event of an error in the hard reset, retry attempts may be performed up to a maximum quantity of retry attempts. A notification may be sent to the mobile device if the maximum quantity of retries is exceeded.

The method may further comprise a post programming session including: (A) sending a functional request to the accessory or ECU enabling receive and transmission by the accessory or ECU; (B) sending a functional request to the accessory or ECU for enabling Diagnostic Trouble Codes.

The method may further comprise sending a functional request to the accessory or ECU for ending Tester Present Service.

The method may further comprise gathering accessory or ECU statistics, accessory or ECU information from Diagnostic Standardized Identifications, and Diagnostic Trouble Codes. The foregoing may be sent to the mobile device.

The method may further comprise removing the update flag.

The mobile device may be a smartphone, a tablet, or a laptop computer.

The over-the-air transmission may be via a network operating under the IEEE 802.11 standards or a cellular network.

The payload may be released to the cloud-based storage platform by a central processor, and the payload may be transmitted to the mobile device from the cloud-based storage platform.

An indication the update is underway, an indication the update is complete, update progress, faults, or any combination thereof may be displayed on a human-machine interface and/or the mobile device.

### BRIEF DESCRIPTION OF THE DRAWINGS

FIG. 1 is a schematic representation of a system according to the present teachings.

FIG. 2 is a flow diagram illustrating a method according to the present teachings.

FIGS. 3A through 3F is a flow diagram illustrating a method according to the present teachings.

### DETAILED DESCRIPTION

The description herein pertains to automotive vehicles. Preferably, it pertains to a vehicle that can be reconfigured from a first vehicle configuration to a second vehicle configuration. The vehicle can be reconfigured back to the first vehicle configuration. In other words, the vehicle has a reversible configurable structure.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory. Components of the present description may be provided as components of original equipment vehicle, and/or provided as aftermarket components for installation on an original equipment vehicle (optionally using at least some of the hardware provided in the original equipment vehicle).

In the context of the present description, one of the vehicle configurations (e.g., first vehicle configuration or second vehicle configuration) may be a truck or pickup truck configuration. In the context of the present description, the other vehicle configuration (e.g., first vehicle configuration or second vehicle configuration) may be a sport utility vehicle (SUV) configuration.

In the context of the present description, a “pickup truck” includes a vehicle that may be a light, medium-duty, or heavy-duty truck. The pickup truck configuration may include a vehicle having an enclosed cab, cockpit, or occupant compartment (for at least a driver and at least one other occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a cab. A pickup truck configuration may be a vehicle that does not include a D-pillar. A pickup truck configuration may be a vehicle that has a removable bulk head panel and rear window or glass assembly that can be completely removed or separated from the vehicle. A pickup truck configuration does not include features of a minivan.

In the context of the present description, a “sport utility vehicle” includes a vehicle that may be a light, medium-duty or heavy-duty vehicle including an enclosed cab (for at least a driver and at least one and preferably a plurality of other occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C- and D-pillars may be added.

The vehicle in accordance with the present teachings (e.g., pickup truck configuration; SUV configuration, or any other configuration) may include a suspension. The suspension may include a solid axle. The suspension may include a de Dion suspension or axle. The suspension may include coil springs. The coil springs may be located forward or rearward of the solid axle and not on the axle. he suspension may be free of any leaf springs. The suspension may include one or more end plates that are integrally formed with the solid axle. The suspension may include a half shaft that extends from the one or more motors through an opening in the end plate.

The vehicle may include a front wheel drive system, a rear wheel drive system, or a combination of front and rear wheel drive (e.g., all-wheel drive system). As part of the reconfiguration, the vehicle may be converted from a rear wheel drive system to a wrong wheel drive system and/or to an all-wheel drive system.

The vehicle disclosed herein may be powered by an electrified powertrain (e.g., it is free of an internal combustion engine). An electrified powertrain may comprise one or more batteries. The one or more batteries may be chargeable by plugging the vehicle into a charging station and/or with regenerative features while the vehicle is in operation. The vehicle may include one or more wheel corner assemblies that include regenerative braking systems. The vehicle may include a front-wheel drive powertrain, a rear-wheel drive powertrain, or an all-wheel drive powertrain. A factory model of the vehicle may include rear-wheel drive or front-wheel drive, and an end user may install an additional motor or powertrain in the vehicle to convert the vehicle into all-wheel drive. The vehicle may comprise one or more motors, hardware, and/or software that allows for a plug-and-play integration when the powertrain is added or converted from front-wheel drive to rear-wheel drive and/or all-wheel drive, or from rear-wheel drive to front-wheel drive and/or all-wheel drive.

### Introduction

The present teachings relate to firmware and/or software updates delivered to a vehicle. Firmware may refer to software that functions for hardware-level control. Firmware may be referred to as software, but software that is not firmware may refer to programming that does not interface with hardware, but rather interacts with the user, and manages memory and processing resources (e.g., operating systems, applications, programming tools, and the like). In this regard, software and firmware may be referred to distinctly in the present etchings, unless otherwise indicated explicitly or by context.

The updates of the present teachings may be delivered over-the-air (OTA). In the context of firmware, this may be referred to as firmware over-the-air (FOTA) and in the context of software, software over-the-air (SOTA). Over-the-air refers to delivering a payload wirelessly. Wireless, as referred to herein, may include, but is not limited to a network operating under the IEEE 802.11 standards (commonly referred to as Wi-Fi™), a cellular network, or a short-range network (e.g., a network operating in the 2.402 GHz to 2.48 GHz frequency bands, commonly referred to as Bluetooth®).

The payload may be delivered wirelessly to a mobile device. The mobile device may then be connected to a vehicle via a wired connection. In this regard, the mobile device may function as a telematics module. It is understood that the vehicle of the present teachings may be free of a telematics module. That is, the vehicle may be free of any on-board wireless communication means. The mobile device may include any mobile computing device. The mobile device may include a smartphone, a tablet, a laptop computer, or the like.

The vehicle of the present teachings is preferably an electric vehicle (EV), although the scope of the present teachings should not be limited to EVs. The system and method of the present teachings may be employed with internal combustion engine (ICE) vehicles.

The vehicle of the present teachings may be reconfigurable, as described herein. In this regard, the vehicle placed in service by the original equipment manufacturer (OEM) may be free of one or more accessories that have become standard features in the modern vehicle market. These accessories may include, but are not limited to, telematics modules, speaker units, displays, lights, radios, infotainment devices, power window controls, power lock controls, power seat controls, climate controls (including cabin temperature and/or seat temperature controls), or any combination thereof. Thus, firmware updates described herein may be related to the addition of devices that were not native to the vehicle when the vehicle placed in service by the original equipment manufacturer (OEM).

The vehicle placed in service by the original equipment manufacturer (OEM) may be free of a telematics module. In this regard, in the present system and method, a mobile device may function, at least temporarily, as a telematics module.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory.

The firmware and/or software updates may also be provided to one or more electronic control units (ECUs). The ECUs may include, but are not limited to, a gateway module, a body control module, a brake control module, a powertrain control module, a suspension control module, a battery management control module, an airbag control module, a climate control module, a lighting control module, or any combination thereof.

### System

The system may comprise a mobile device. The mobile device may function as a telemetry module, at least temporarily. Firmware and/or software updates may be transmitted from the mobile device to a gateway module.

The system may comprise a vehicle. Preferably, the vehicle is an EV. The vehicle may be free of a telematics module. The vehicle may comprise one or more accessories, one or more ECUs, or both. The firmware and/or software updates may be pushed to accessories, ECUs, or both.

The ECUs may comprise one or more controllers, memory, inputs, outputs, communication modules, or any combination thereof.

The accessories may comprise one or more controllers, memory, inputs, outputs, communication modules, or any combination thereof.

The vehicle may comprise a vehicle network. The accessories, ECUs, or both may communicate via the vehicle network. The vehicle network may be in the form of a CAN bus. The firmware and/or software updates may be pushed to accessories, ECUs, or both over the vehicle network.

The vehicle may comprise a three bus architecture. The gateway module may signally communicate with all three busses. The busses may include a chassis CAN, a body CAN, and an HV electric CAN. The chassis CAN may include safety systems (e.g., air bags, crash sensors, buckle sensors, and the like) and chassis systems (e.g., braking boosters, actuators, wheel speed sensors, and the like). The body CAN may include body systems (e.g., lighting, locks, wipers, occupant sensors, and the like). The HV electric CAN may include vehicle propulsion systems, climate systems, and other high voltage systems.

The vehicle may comprise a gateway module. The gateway module may be an ECU on-board the vehicle that manages pushing firmware and/or software updates to the requisite accessories and/or ECUs.

The vehicle may comprise one or more human-machine interfaces. The human-machine interface may comprise a display. The display may be for displaying a digital instrument cluster.

The vehicle may comprise one or more data ports. The one or more data ports may function to connect the mobile device to the gateway module. The one or more data ports may be in the form of USB (e.g., USB-A, USB-B, USB-C, Mini-USB, Micro-USB, or USB-3), Lightning, on-board diagnostics (OBD), or any other suitable data connection.

The system may comprise a central processor. The central processor may be the author of the firmware and/or software updates.

The system may comprise one or more cloud-based storage platforms. The central processor may store firmware and/or software updates to the cloud-based storage platform. The cloud-based storage platform may function as a repository for firmware and/or software updates, from which a mobile device may download the firmware and/or software updates.

### Method

The method may comprise one or more of the following steps. Some of the steps may be duplicated, removed or eliminated, rearranged relative to other steps, combined into one or more steps, separated into two or more steps, or a combination thereof.

The method relates to updating firmware and/or software of one or more accessories, one or more ECUs, or both. The updates may involve deleting and/or overwriting existing firmware and/or software or at least portions thereof. The updates may be performed to fix bugs, patch security holes, improve performance, modify user experience, add new features, remove features, improve safety features, ensure compatibility between devices, accommodate the installation or removal of one or more accessories from the vehicle, or any combination thereof.

The method may comprise releasing one or more firmware and/or software updates from a central processor to a cloud-based storage platform. The data of the firmware and/or software update may be referred to herein as the payload. The payload may be delivered to the cloud-based storage platform in binary format (e.g., Binary Large OBject). The payload may be delivered to the mobile device in binary format. The payload may be converted by the mobile device and/or gateway module to the Intel hexadecimal object file format. The conversion to Intel hexadecimal object file format may include inserting a set of instructions for the gateway module. In this regard, the set of instructions directs the gateway module in parsing the update file and targeting accessories or ECUs receiving the update file.

The method may comprise comparing an accessory and/or ECU list with the one or more firmware and/or software updates available on the cloud-based storage platform. The firmware and/or software update may be associated with one or more accessories and/or ECUs. Accordingly, an accessory or ECU may be identified by an identifier, e.g., a serial number, model number, part number, or the like. The method may comprise performing a functional request for all accessories and/or ECUs for their identifiers. The functional request may also determine a version of firmware/software currently installed. The method may comprise compiling a list of the identifiers from the functional request.

Functional request, as referred to herein, may mean a standardized message sent over the vehicle network (e.g., CAN bus) to accessories and/or ECUs for data requests or requests to perform a diagnostic function. The functional requests may be sent to all accessories and/or ECUs, and only the accessories and/or ECUs with the relevant data responds to the request. The functional requests may be sent to target accessories and/or ECUs. Target, in this context, may refer to those accessories and/or ECUs that have a firmware and/or software update available.

The user may initiate a check for updates, or an automated check for updates may be performed periodically by a mobile device. Accordingly, the list of identifiers may be compared to the firmware and/or software update(s) released to the cloud-based storage platform.

The method may comprise pushing a notification to a mobile device from the central processor. The notification may indicate availability of the firmware and/or software update. The notification may be communicated via email, short message service (SMS), an application (e.g., an application dedicated to firmware and/or software updates, or an application associated with the vehicle), or any combination thereof.

A user of the mobile device may accept or deny the payload. Upon acceptance of the payload, the payload may be transmitted to the mobile device over-the-air. The payload may be split into a plurality of different segments. Each segment may relate to different parts of an update for a single accessory and/or ECU (e.g., a security patch and a functionality update for one ECU). The payload may include one or more blocks. Blocks may refer to updates for different accessories and/or ECUs. That is, each block may be directed to one accessory or ECU. A block may comprise one or more segments, as described above.

In this regard, the method of the present teachings may provide for updates to multiple accessories and/or ECUs in a single campaign. That is, a single campaign may handle non-contiguous payloads.

The method may comprise authenticating the mobile device. The mobile device may be authenticated by ensuring the mobile device is owned by the registered owner of the vehicle. The authentication may involve verifying a name or username, phone number, email address, or other personal information, and a password. The authentication may involve a time-based one-time password (e.g., delivered via SMS, email, or an authenticator app. The authentication may involve a certificate-based authentication. One or any combination of the foregoing approaches may be undertaken. In this regard, the authentication may be a one-factor authentication or a two-factor authentication.

Authenticating ownership of the vehicle and the mobile device may prohibit unauthorized access to the vehicle devices, e.g., by spoofing to gain access to vehicle devices and updating with unauthorized firmware and/or software. Although typically a registered owner of the vehicle may be authenticated, the present teachings contemplate additional permissions being grantable by the owner to, e.g., family members or other authorized vehicle operators.

The mobile phone may be authenticated before the payload is transmitted to the mobile phone or before the payload is transmitted to the gateway module.

The method may comprise validating the payload. The validation may be performed by the mobile device. The validation may include a cycle redundancy check (CRC) (e.g., according to CRC-32), validating signatures and/or certificates (e.g., according to SHA-256 and an Elliptic Curve Digital Signature Algorithm (ECDSA) such as P-256 or P-384), validating compatibility of the payload with the target accessory or ECU (e.g., comparing serial numbers, model numbers, part numbers, version history, or the like), validating a memory storage medium capacity available to receive the payload, or any combination thereof.

In the event of an error, the mobile device may reject the payload and notify the cloud-based storage platform. A failure report may be displayed to the user on the mobile device. The payload may then be re-transmitted to the mobile device. The payload may be re-transmitted autonomously, or on direction of the user through the mobile device.

The method of the present teachings may involve a plurality of validation steps at different stages as described herein. The plurality of validation steps may aid users in executing firmware and/or software updates, without the need to take the vehicle to a service center or otherwise rely on professional services. The validations in each stage may allow any errors to be identified and rectified in different stages, rather than restarting the process from the beginning. The plural validation steps may lead to faster update processes, compared to a single validation performed toward the end of the process, which may restart the process from the beginning if there are any errors. It is also understood that the method of the present teachings is generally more interactive than typical update procedures in service centers.

The method of the present teachings is unique in the sense that the update is monitored and controlled by a vehicle owner rather than a service technician. In this regard, additional security measures are taken to ensure the mobile device of the vehicle owner matches with registration information of the vehicle. Additionally, two or more validation steps may be performed at the mobile device level and the gateway module level and optionally at the accessory and/or ECU level to allow for retry iterations in the event of errors, and communicating errors and fix recommendations to a user to facilitate the update.

The method may comprise waiting for flash conditions to be met. The flash conditions may include confirming a wired connection between the mobile device and the gateway module, a battery condition of the mobile device, and/or a battery condition of the vehicle.

The method may comprise connecting the mobile device to the vehicle. The mobile device may be connected to the gateway module. The mobile device may be connected via a data port or a wireless network, preferably a data port. Thus, the mobile device may signally communicate with the gateway module. The payload may be transmitted to the gateway module via the wired connection.

The method may comprise validating the payload. The payload may be validated by the gateway module. The validation may include a cycle redundancy check (CRC) (e.g., according to CRC-32), validating signatures and/or certificates (e.g., according to SHA-256 and an Elliptic Curve Digital Signature Algorithm (ECDSA) such as P-256 or P-384), validating compatibility with the associated accessory and/or ECU (e.g., comparing serial numbers, model numbers, part numbers, version history, or the like), validating memory storage medium capacity available to receive the payload, or any combination thereof.

In the event of an error, the gateway module may reject the payload and notify the mobile device. A failure report may be displayed to the user on the mobile device and/or a human-machine interface on-board the vehicle. The payload may then be re-transmitted to the gateway module. The payload may be re-transmitted autonomously, or on direction of the user through the mobile device.

After the payload is transmitted to the gateway module and its validation, the mobile device may be removed from connection to the vehicle and the gateway module may perform the firmware and/or software update. Thus, a user may not need to monitor the update or lose access to their mobile device for the duration of the firmware and/or software update.

The method may comprise checking a pre-condition sequence. The pre-condition sequence may include ensuring the vehicle is in park and/or has a vehicle speed of 0 km/h, ensuring a sufficient vehicle battery condition and/or ensuring the vehicle is connected to a charger, setting an update flag (notifying the accessory or ECU an update is being performed), disabling propulsion of the vehicle (via ECU(s) responsible for vehicle propulsion), ensuring that a delay time has been met, ensuring the software update file was received by the gateway module, or any combination thereof. Vehicle propulsion may remain disabled during the firmware and/or software update.

In the event of an error in the pre-condition sequence retry attempts may be performed up to a maximum quantity of retry attempts. If a maximum quantity of retries is exceeded, A failure report may be displayed to the user on the mobile device and/or a human-machine interface on-board the vehicle.

The park status may be verified by a signal from a gear position sensor. The vehicle speed may be detected by global positioning system (GPS), a speedometer, a wheel speed sensor, or any combination thereof. The battery condition may be a voltage (e.g., 12V to 16V) and/or a state of charge (e.g., about 10% of charge capacity or more, more preferably about 30% of charge capacity or more, more preferably about 50% of charge capacity or more, more preferably about 60% of charge capacity or more, or even more preferably about 70% of charge capacity or more).

The method may comprise gathering accessory and/or ECU statistics, accessory and/or ECU information from Diagnostic Standardized Identifications, and Diagnostic Trouble Codes.

One or more parts of the method may employ Unified Diagnostic Services (UDS), such as defined by ISO 14229, incorporated herein by reference for all purposes.

The method may comprise sending a functional request to the accessory or ECU for Tester Present. The functional request may be sent on a periodic basis (e.g., every 0.5 second to every 5 seconds; preferably every 1 second). Tester present service may be used to notify an accessory or ECU that the diagnostic tester is still active during a session, preventing the accessory or ECU from closing the session due to inactivity.

The method may comprise sending a functional request to the accessory or ECU for Diagnostic Session Control to change to a diagnostic session. That is, allowing access to diagnostic functions. The method may comprise checking programming pre-conditions in a Routine Control Service. That is, ensuring the firmware and/or software update version and the accessory or ECU identifier (e.g., part number) are consistent. The method may comprise sending a functional request to the accessory or ECU for disabling Diagnostic Trouble Codes. The method may comprise sending a functional request to the accessory or ECU enabling receive by the accessory or ECU and disabling transmission by the accessory or ECU. The method may comprise executing a program counter, for attempts to read data. An error in one or any combination of the foregoing may result in a retry loop up to a maximum quantity of retries. A notification may be sent to the mobile device and/or a human-machine interface if the maximum quantity of retries is exceeded.

Preferably, the method may comprise sending a functional request to the accessory or ECU for Diagnostic Session Control to change to a diagnostic session; checking programming pre-conditions in a Routine Control Service; sending a functional request to the accessory or ECU for disabling Diagnostic Trouble Codes; sending a functional request to the accessory or ECU enabling receive by the accessory or ECU and disabling transmission by the accessory or ECU; and executing a program counter. It has been found that this sequence of steps ensures proper and consistent functionality across all vehicle systems. For example, it was found that for some modules, checking preconditions first before disabling the Diagnostic Trouble Codes was needed for proper update functionality.

The method may comprise a main programming session. The main programming session may include starting a programming session, sending a seed request from the gateway module to the accessory or ECU and sending the seed back from the accessory or ECU to the gateway module, generating a key by the gateway module and validating the key by the accessory or ECU, and entering a Write Data by Identifier Service. The firmware and/or software update may overwrite at least part of the existing memory. The memory to be overwritten may be outlined in the payload.

In the event of a No Response Code or no response from the accessory or ECU in any of the foregoing sub-steps, retry attempts may be performed up to a maximum quantity of retry attempts. A hard reset of the accessory or ECU may be performed if the maximum quantity of retries is exceeded. A failure report may be displayed to the user on the mobile device and/or a human-machine interface on-board the vehicle.

The method may comprise an erase, download, and check services session. The erase, download, and check services session may include erasing memory; sending a download request to the accessory or ECU; transmitting payload data and/or data segments; checking memory in a Routine Control Service; and detecting additional data blocks for one or more firmware and/or software updates for one or more additional accessories and/or ECUs. In the event of additional data blocks the foregoing sub-steps may be performed for each data block.

In the event of a No Response Code or no response from the accessory or ECU in any of the foregoing sub-steps, retry attempts may be performed up to a maximum quantity of retry attempts. A hard reset of the accessory or ECU may be performed if the maximum quantity of retries is exceeded. A failure report may be displayed to the user on the mobile device and/or a human-machine interface on-board the vehicle.

The method may comprise checking programming dependencies in a Routine Control Service. That is, checking compatibility of the upgrade, such as checking the part number of the upgrade file, and checking whether the necessary logic blocks exist.

The method may comprise performing a hard reset. In the event of an error in the hard reset, retry attempts may be performed up to a maximum quantity of retry attempts. A failure report may be displayed to the user on the mobile device and/or a human-machine interface on-board the vehicle if the maximum quantity of retries is exceeded.

The method may comprise a post-programming session. The post-programming session may comprise sending a functional request to the accessory and/or ECU enabling receive and transmission by the accessory and/or ECU and sending a functional request to the accessory and/or ECU for enabling Diagnostic Trouble Codes.

The method may comprise sending a functional request to the accessory or ECU for ending Tester Present Service.

The method may comprise gathering accessory and/or ECU statistics, accessory and/or ECU information from Diagnostic Standardized Identifications, and Diagnostic Trouble Codes. The foregoing may be sent to the mobile device.

The method may comprise removing the update flag. The method may comprise sending a propulsion safe signal to terminate vehicle safe status and allow propulsion of the vehicle.

The method may comprise transmitting a notification to the mobile device and/or a vehicle display of completion of the update process.

The firmware and/or software update may have a duration of about 30 seconds or more, 1 minute or more, 2 minutes or more, 3 minutes or more, or even 4 minutes or more. The firmware and/or software update may have a duration of about 20 minutes or less, 15 minutes or less, 10 minutes or less, or even 5 minutes or less.

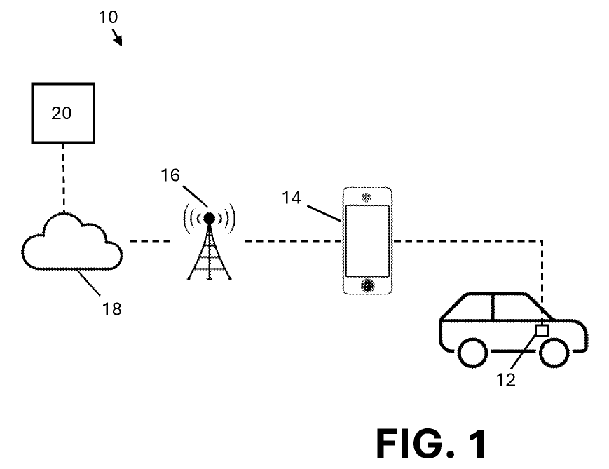

FIG. 1 is a schematic representation of an exemplary system 10 of the present teachings. The system 10 comprises a vehicle 12 in communication with a mobile device 14, which signally communicates via a network 16 (e.g., a wireless network) with a cloud-based storage platform 18 to which a central controller 20 uploads updates.

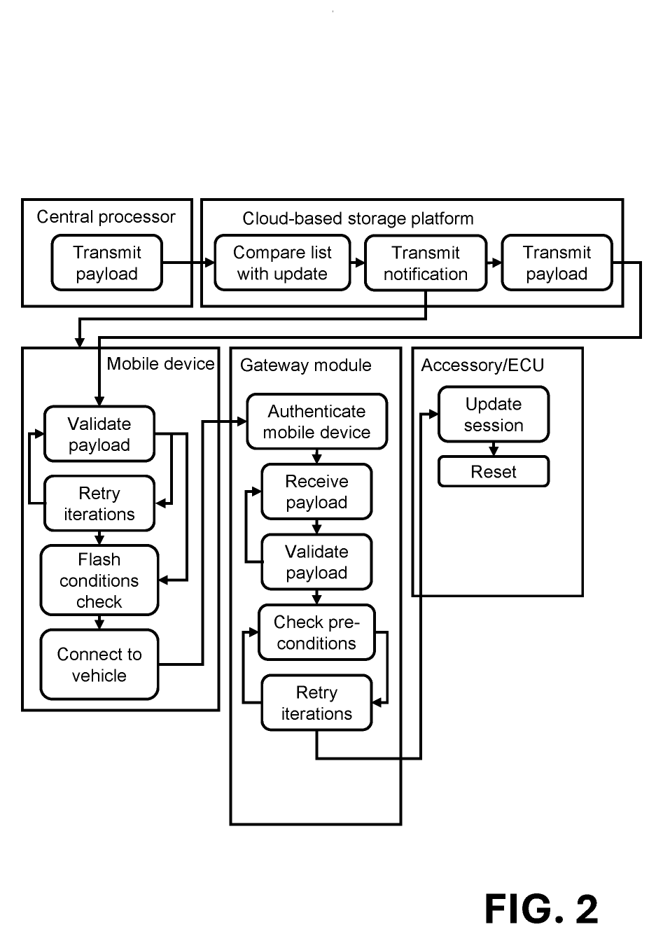

FIG. 2 illustrates an exemplary method of the present disclosure. The method initiates with releasing a firmware and/or software update from a central processor to a cloud-based storage platform. A list of accessories and/or ECUs are compared with the one or more firmware and/or software updates to determine correspondence. The user is notified that the software update is available (e.g., via email, short message service (SMS), and/or an application stored on the customer mobile device).

The payload is transmitted to the mobile device and the payload is validated. The validation may take one or more iterations, multiple iterations if there are any errors. An error log may be sent to the mobile device or displayed on a display on-board the vehicle. Flash conditions are checked prior to transmitting the payload to the gateway module. Prior to transmission, the mobile device may be authenticated to ensure proper correspondence with the vehicle. That is, the registered owner of the mobile device must correspond with the registered owner of the vehicle.

The payload is then transmitted to the gateway module. The payload is validated at the gateway module level. The validation may take one or more iterations, multiple iterations if there are any errors. An error log may be sent to the mobile device or displayed on a display on-board the vehicle.

Pre-conditions are checked as described herein. The check may take one or more iterations, multiple iterations if there are any errors. An error log may be sent to the mobile device or displayed on a display on-board the vehicle. Vehicle immobilization, which is a part of the pre-conditions, may be maintained throughout the update.

The update is initiated and a status thereof may be displayed on the mobile device and/or a display on-board the vehicle. The one or more accessories and/or ECUs are caused to reset. Vehicle immobilization may then be ceased.

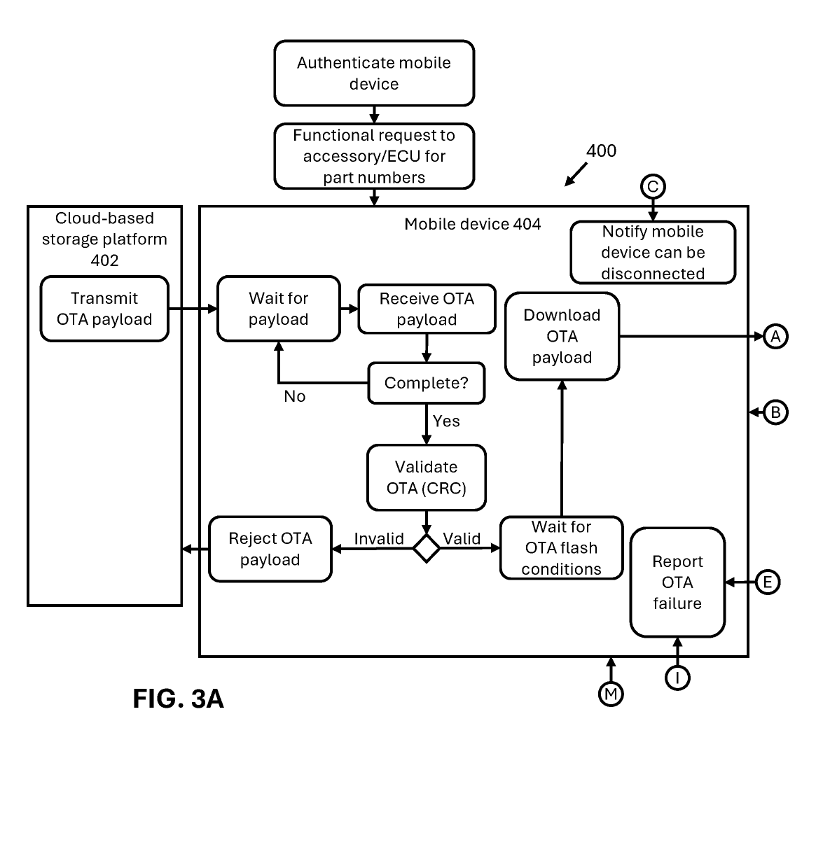

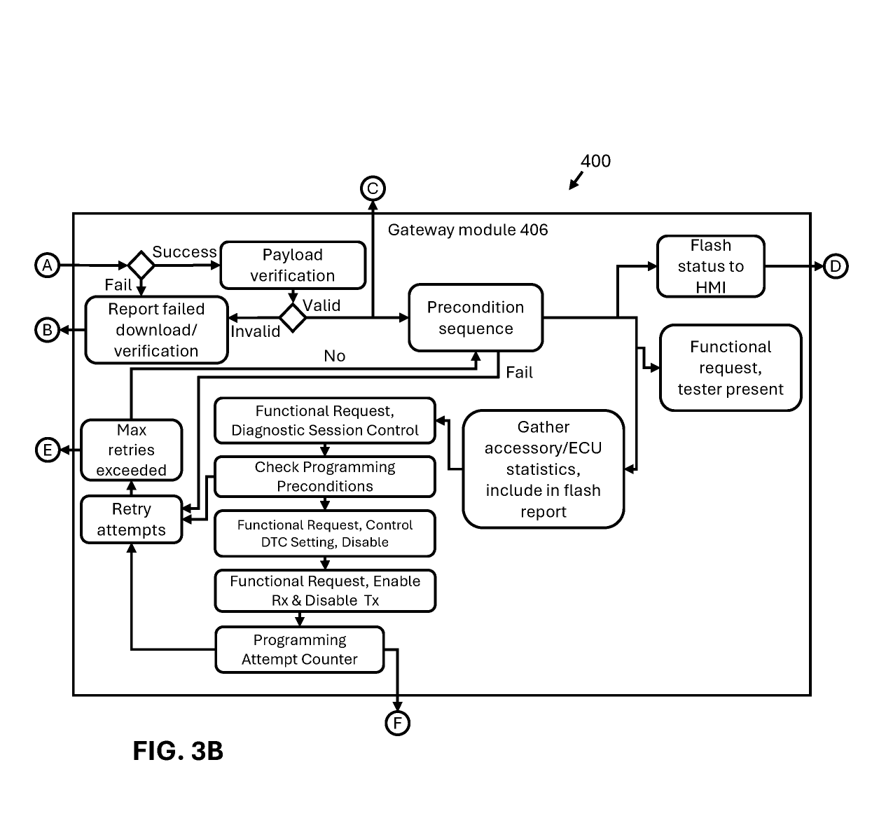

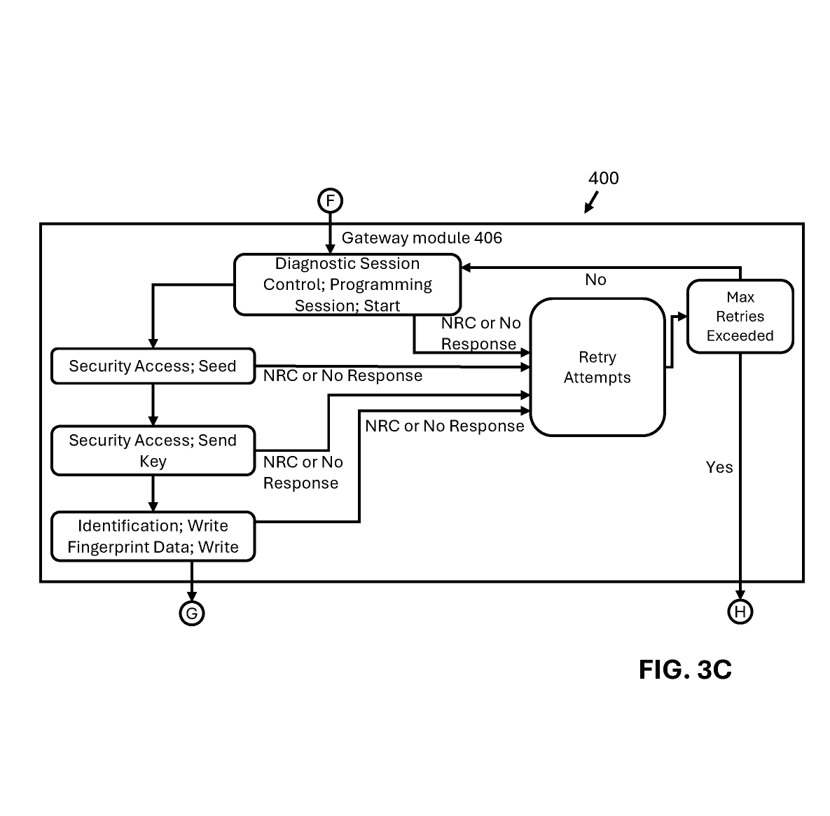

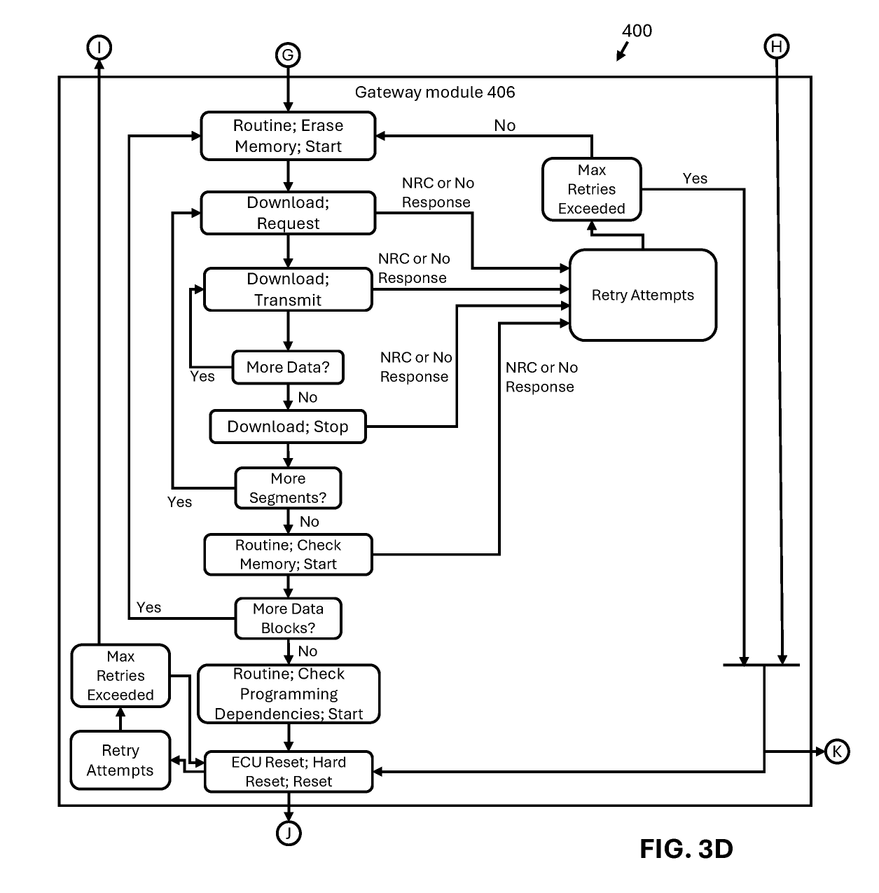

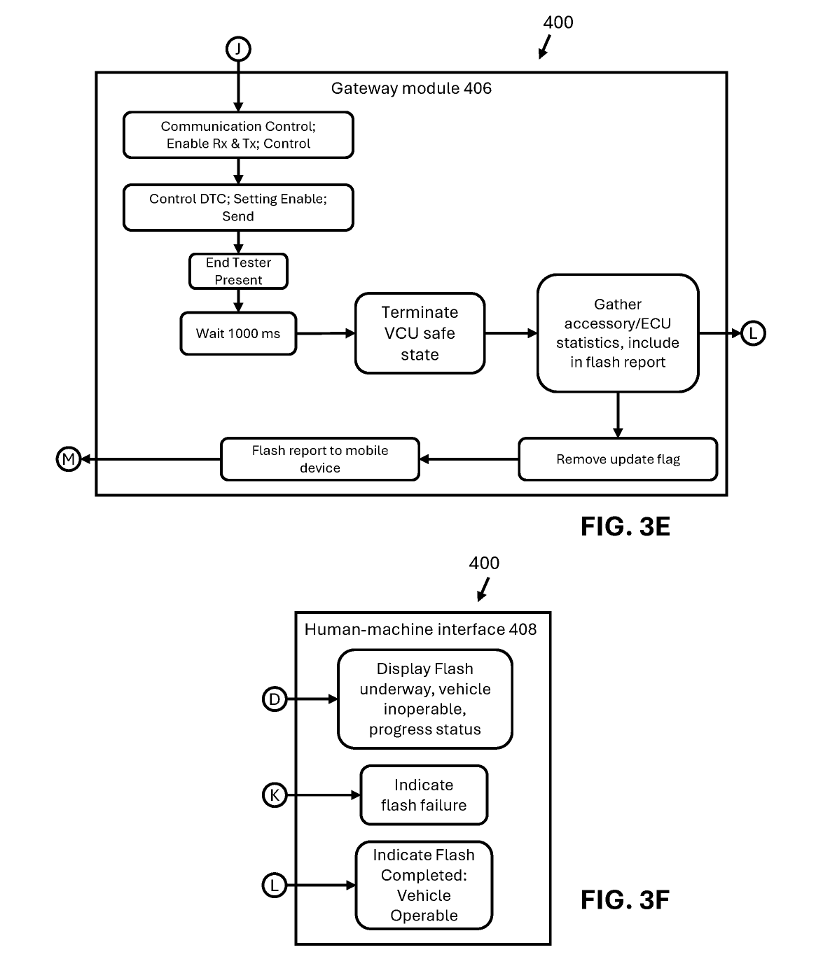

FIGS. 3A through 3F illustrate an exemplary method 400 of the present teachings. A payload is transmitted from a cloud-based storage platform 402 to a mobile device 404. The payload is validated. If the validation fails, the payload is rejected, and the transmission from the cloud-based storage platform 402 can be retried. If the validation succeeds, the payload is transmitted to a gateway module 406 after flash conditions are realized. Exemplary flash conditions may include a connection to the gateway module 406, sufficient battery life of the mobile device 404, sufficient battery conditions of the vehicle, or any combination thereof.

The mobile device 404 is authenticated relative to the vehicle. That is, it is verified that the owner of the mobile device 404 is also the owner of the vehicle. Such verification may be performed between a central processor and the mobile device 404, between the gateway module 406 and the mobile device 404, or any combination thereof. After the authentication of the mobile device 404, the mobile device 404 can execute a functional request for accessory or ECU part numbers for all accessories and/or ECUs on-board the vehicle. In this regard, the part numbers of the accessories and/or ECUs can be compared to any updates uploaded to the cloud based storage platform 402.

The gateway module 406 performs a pre-programming session (FIG. 3B); a main programming session (FIG. 3C); an erase, download, and check services session (FIG. 3D), and a post-programming session (FIG. 3E).

In the pre-programming session, the payload is downloaded. Any failure in the download results in a notification to the mobile device 404, and the download can be retried. After successful download, the payload is verified as described herein. After validation, a precondition sequence is performed as described herein.

In the event the precondition sequence fails, one or more retry attempts may be performed. The retry attempts may be performed up to a maximum quantity of retry attempts, and if the same is exceeded, a failure report is sent to the mobile device. After success of the precondition sequence, a status is sent to a human-machine interface, such as a dashboard on-board the vehicle and/or the mobile device, and a functional request is initiated for a Tester Present Service. The functional request may be repeated on a periodic basis (e.g., every 1 second). A functional request for Diagnostic Identification and/or Diagnostic Trouble Codes may be made for a Flash Report.

A functional request of Diagnostic Session Control request is sent to the accessory or ECU to change the session to a programming session, allowing access to diagnostic functions. A check for programming preconditions is then performed. A functional request disabling Diagnostic Trouble Codes is sent to the accessory or ECU. A functional request enabling receive by the accessory or ECU and disabling transmission by the accessory or ECU. A program counter is performed for attempts to read data.

In the event of a failure of the precondition sequence, the programming preconditions, and/or the program counter, retry attempts are performed up to a maximum quantity of retry attempts. A report to the mobile device is performed if the maximum quantity of retries is exceeded.

In the main programming session, a diagnostic session of the accessory or ECU is changed to a programming session. A seed request is sent from the gateway module to the accessory or ECU. The seed is sent back from the accessory or ECU to the gateway module. A key is sent by the gateway module and the accessory or ECU validates the key. Write Data by Identifier Service is entered. In the event of a No Response Code or no response from the accessory or ECU, retry attempts are performed up to a maximum quantity of retry attempts. A hard reset of the accessory or ECU is performed if the maximum quantity of retries is exceeded.

In the erase, download, and check services session, memory of the accessory or ECU is erased, a download request is transmitted, a download is transmitted, and checks for additional data, segments, and/or data blocks are performed. After a successful download, a hard reset of the accessory or ECU is performed.

In the event a No Response Code or no response from the accessory or ECU, retry attempts are performed up to a maximum quantity of retry attempts. A hard reset of the accessory or ECU is performed if the maximum quantity of retries is exceeded.

For the hard resets described in the immediately foregoing paragraphs, if there is an error in the hard resets, retry attempts are performed up to a maximum quantity of retry attempts. If the maximum quantity of retries are exceeded, a failure report is sent to the mobile device 404.

In the post-programming session, transmission and receiving of the accessory or ECU are enabled. Diagnostic Trouble Codes are enabled. The Tester Present Service is ended. A waiting period is undertaken. The vehicle propulsion may be enabled (via vehicle control units). The update flag may be removed. A flash report is provided to the mobile device 404.

In the pre-programming session, flash status is transmitted to a human-machine interface 408. In the erase, download, and check services session, a maximum quantity of retries triggers a flash failure notification at the human-machine interface 408. In the post-programming session, the flash report may be transmitted to the human-machine interface 408.

A vehicle control 408 may deny or permit vehicle operation. A Human Machine Interface (HMI) 410 (e.g., instrument cluster display) may indicate flash/update progress and whether the vehicle is operable or inoperable.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

### Examples

Ex.1. A method of updating vehicle firmware and/or software.

Ex.1.1. The method may comprise: releasing a software update file from a central processor to a cloud-based storage platform; notifying a customer mobile device from the central processor that the software update file is available for download; authenticating, by the central processor, the customer mobile device to verify that the customer mobile device is capable of receiving the software update file; downloading, by the customer mobile device, the software update file from the cloud-based storage platform via an electronic communication network; connecting, by the customer mobile device, the customer mobile device to a gateway module in the vehicle; authenticating, by the central processor, the customer mobile device to verify that the customer mobile device is authorized to connect to the gateway module; transferring, by the customer mobile device, the software update file from the customer mobile device to the gateway module, wherein the gateway module is not configured to connect to the electronic communication network; verifying, by the gateway module, that one or more safety precautions are met; instructing, by the customer mobile device, the gateway module to begin a software update process using the software update file; updating, by the gateway module, the vehicle software; notifying, by the customer mobile device, a customer of completion of the software update process; and logging, by the central processor, an update status of the vehicle on the cloud-based storage platform using information from the customer mobile device. The vehicle may not include a telematics module configured to connect to the electronic communication network.

Ex.1.2. The software update file may be split into a plurality of software update files.

Ex.1.3. The method may comprise notifying the customer mobile device that the software update file is available for download is done via email, text, mobile device application, phone call, video call, and/or mail.

Ex.1.4. The customer mobile device may be a phone, tablet, computer, or smartwatch.

Ex.1.5. The electronic communication network may be a cellular network or a Wi-Fi network.

Ex.1.6. The method may comprise connecting, by the customer mobile device, the customer mobile device to the gateway module and transferring, by the customer mobile device, the software update file from the customer mobile device to the gateway module is done via Bluetooth, a Wi-Fi network, a cellular network, or a cable.

Ex.1.7. The one or more safety precautions may include ensuring the vehicle is in park, ensuring the vehicle has sufficient battery charge, ensuring the vehicle is connected to a charger, ensuring that configured delay time has been met, and/or ensuring the software update file was received by the gateway module.

Ex.1.8. The method may comprise verifying, by the gateway module, that the vehicle is in park via the customer mobile device, a GPS satellite, a speedometer, and/or a transmission attachment.

Ex.1.9. Instructing, by the customer mobile device, the gateway module to begin the software update process using the software update file may be done via a mobile device application.

Ex.1.10. The vehicle may be immobilized while updating, by the gateway module, the vehicle software.

Ex.1.11. The method may comprise notifying, by the customer mobile device, the customer of completion of the software update process is done via email, text, mobile device application, phone call, video call, and/or mail.

Ex.1.12. The central processor may be configured to access the update status of the vehicle via the mobile device application on the customer mobile device, and wherein the central processor may not be configured to access the update status of the vehicle via the gateway module.

Ex.1.13. The method may further comprise validating, by the customer mobile device, a firmware over-the-air (FOTA) cyclic redundancy check (CRC) and signatures and/or certificates.

Ex.1.14. The method may further comprise notifying, by an instrument panel cluster in the vehicle, a customer of completion of the software update process.

The foregoing examples may be applicable to all embodiments.

Ex.2. A method of updating vehicle firmware and/or software.

Ex.2.1. The method may comprise downloading, by a customer mobile device, a software update file from a cloud-based storage platform via an electronic communication network; connecting, by the customer mobile device, the customer mobile device to a gateway module in the vehicle; transferring, by the customer mobile device, the software update file from the customer mobile device to the gateway module, wherein the gateway module is not configured to connect to the electronic communication network; and updating, by the gateway module, the vehicle software.

Ex.2.2. The method may further comprise releasing the software update file from a central processor to the cloud-based storage platform.

Ex.2.3. The method may further comprise notifying the customer mobile device from a central processor that the software update file is available for download.

Ex.2.4. The method may further comprise authenticating, by a central processor, the customer mobile device to verify that the customer mobile device is capable of receiving the software update file.

Ex.2.5. The method may further comprise authenticating, by a central processor, the customer mobile device to verify that the customer mobile device is authorized to connect to the gateway module.

Ex.2.6. The method may further comprise verifying, by the gateway module, that one or more safety precautions are met.

Ex.2.7. The method may further comprise instructing, by the customer mobile device, the gateway module to begin a software update process using the software update file.

Ex.2.8. The method may further comprise notifying, by the customer mobile device, a customer of completion of a software update process.

Ex.2.9. The method may further comprise logging, by a central processor, an update status of the vehicle on the cloud-based storage platform using information from the customer mobile device.

Ex.2.10. The vehicle may not include a telematics module configured to connect to the electronic communication network.

Ex.2.11. The software update file may be split into a plurality of software update files.

Ex.2.12. Notifying the customer mobile device that the software update file is available for download may be done via email, text, mobile application, phone call, video call, and/or mail.

Ex.2.13. The customer mobile device may be a phone, tablet, computer, or smartwatch.

Ex.2.14. The electronic communication network may be a cellular network or a Wi-Fi network.

Ex.2.15. Connecting, by the customer mobile device, to the gateway module and transferring, by the customer mobile device, the software update file from the customer mobile device to the gateway module may be done via Bluetooth, a Wi-Fi network, a cellular network, or a cable.

Ex.2.16. The one or more safety precautions may include ensuring the vehicle is in park, ensuring the vehicle has sufficient battery charge, ensuring the vehicle is connected to a charger, ensuring that configured delay time has been met, and/or ensuring the software update file was received by the gateway module.

Ex.2.17. Verifying, by the gateway module, that the vehicle is in park may be done via a customer mobile device, a GPS satellite, a speedometer, and/or a transmission attachment.

Ex.2.18. Instructing, by the customer mobile device, the gateway module to begin the software update process using the software update file may be done via a mobile device application.

Ex.2.19. The vehicle may be immobilized while updating, by the gateway module, the vehicle software.

Ex.2.20. Notifying, by the customer mobile device, the customer of completion of the software update process may be done via email, text, mobile device application, phone call, video call, and/or mail.

Ex.2.21. A central processor may be configured to access an update status of the vehicle via a mobile device application on the customer mobile device, and wherein the central processor may not be configured to access the update status of the vehicle via the gateway module.

Ex.2.22. The method may further comprise validating, by the customer mobile device, a firmware over-the-air (FOTA) cyclic redundancy check (CRC) and signatures and/or certificates.

Ex.2.23. The method may further comprise notifying, by an instrument panel cluster in the vehicle, a customer of completion of the software update process.

### REFERENCE NUMERALS

10 system

12 gateway module

14 mobile device

16 network

18 cloud-based storage platform

20 central controller

400 method

402 cloud-based storage platform

404 mobile device

406 gateway module

408 HMI

What is claimed is:

1. A method of updating firmware and/or software in a vehicle, comprising:
transmitting a payload of a firmware and/or software update to a mobile device over-the-air, the payload corresponding with a target accessory or ECU of the vehicle,
authenticating the mobile device relative to the vehicle,
transmitting the payload to the vehicle via a wired connection, and
performing one or more validations of the payload at the mobile device and/or the vehicle.

2. The method according to claim 1, wherein the authentication confirms the owner of the mobile device is the owner of the vehicle.

3. The method according to claim 2, wherein the mobile device signally communicates with a gateway module of the vehicle, which receives the payload and pushes the payload to the accessory or ECU.

4. The method according to claim 3, wherein the vehicle is free of an on-board telematics module.

5. The method according to claim 4, wherein the vehicle is an electric vehicle; and wherein the vehicle is a reconfigurable vehicle.

6. The method according to claim 5, wherein the one or more validations includes, at the mobile device, a cycle redundancy check, validating signatures and/or certificates, validating compatibility of the payload with the associated accessory or ECU, validating memory storage medium capacity available to receive the payload, or any combination thereof; preferably at least a cycle redundancy check; and wherein an error results in the mobile device rejecting the payload, and optionally re-transmitting the payload to the mobile device.

7. The method according to claim 6, further comprising performing a functional request to all accessories and/or ECUs on-board the vehicle for an identifier (e.g., a part number); and comparing the identifiers with all firmware and/or software updates available on a cloud-based storage platform.

8. The method according to claim 7, wherein the one or more validations includes, at the gateway module, a cycle redundancy check, validating signatures and/or certificates, validating compatibility of the payload with the associated accessory and/or ECU, validating memory storage medium capacity available to receive the payload, or any combination thereof; and wherein an error results in the gateway module rejecting the payload, and optionally re-transmitting the payload to the gateway module.

9. The method according to claim 8, further comprising disconnecting the mobile device from the vehicle after successful validation at the gateway module.

10. The method according to claim 9, further comprising a pre-condition sequence including: (A) ensuring the vehicle is in park and/or has a vehicle speed of 0 km/h; (B) ensuring a sufficient vehicle battery condition and/or ensuring the vehicle is connected to a charger; (C) setting an update flag; (D) disabling propulsion of the vehicle; or any combination thereof; wherein propulsion of the vehicle remains disabled during the firmware and/or software update; and optionally in the event of an error in the pre-condition sequence retry attempts are performed up to a maximum quantity of retry attempts, and if a maximum quantity of retries is exceeded, reporting failure to the mobile device.

11. The method according to claim 10, further comprising gathering accessory or ECU statistics, accessory or ECU information from Diagnostic Standardized Identifications, and Diagnostic Trouble Codes.

12. The method according to claim 11, further comprising sending a functional request to the accessory or ECU for Tester Present; and wherein the functional request is sent on a periodic basis.

13. The method according to claim 12, further comprising: (A) sending a functional request to the accessory or ECU for Diagnostic Session Control to change to a diagnostic session; (B) checking programming pre-conditions in a Routine Control Service; (C) sending a functional request to the accessory or ECU for disabling Diagnostic Trouble Codes; (D) sending a functional request to the accessory or ECU enabling receive by the accessory or ECU and disabling transmission by the accessory or ECU; and (E) executing a program counter; wherein an error in (B) or (E) results in a retry loop up to a maximum quantity of retries; and wherein a notification is sent to the mobile device if the maximum quantity of retries is exceeded.

14. The method according to claim 13, further comprising a main programming session including: starting a programming session, sending a seed request from the gateway module to the accessory or ECU and sending the seed back from the accessory or ECU to the gateway module, generating a key by the gateway module and validating the key by the accessory or ECU, and entering a Write Data by Identifier Service; and wherein in the event of a No Response Code or no response from the accessory or ECU in any of the foregoing sub-steps, retry attempts are performed up to a maximum quantity of retry attempts; and wherein a hard reset of the accessory or ECU is performed if the maximum quantity of retries is exceeded.

15. The method according to claim 14, further comprising an erase, download, and check services session including: (A) erasing memory; (B) sending a download request to the accessory or ECU; (C) transmitting payload data and/or data segments; (D) checking memory in a Routine Control Service; and (E) detecting additional data blocks for one or more firmware and/or software updates for one or more additional accessories and/or ECUs, and executing steps (A) through (E) in the erase, download, and check services session; and wherein in the event of a No Response Code or no response from the accessory or ECU in any of the foregoing sub-steps, retry attempts are performed up to a maximum quantity of retry attempts; and wherein a hard reset of the accessory or ECU is performed if the maximum quantity of retries is exceeded.

16. The method according to claim 15, further comprising: checking programming dependencies in a Routine Control Service, and performing a hard reset; wherein in the event of an error in the hard reset, retry attempts are performed up to a maximum quantity of retry attempts; and wherein a notification is sent to the mobile device if the maximum quantity of retries is exceeded.

17. The method according to claim 16, further comprising a post programming session including: (A) sending a functional request to the accessory or ECU enabling receive and transmission by the accessory or ECU; (B) sending a functional request to the accessory or ECU for enabling Diagnostic Trouble Codes.

18. The method according to claim 17, further comprising sending a functional request to the accessory or ECU for ending Tester Present Service.

19. The method according to claim 18, further comprising: gathering accessory or ECU statistics, accessory or ECU information from Diagnostic Standardized Identifications, and Diagnostic Trouble Codes, optionally sending the same to the mobile device; and removing the update flag.

20. The method according to claim 19, wherein mobile device is a smartphone, a tablet, or a laptop computer; and wherein the over-the-air transmission is via a network operating under the IEEE 802.11 standards or a cellular network.
